(19) United States
(12) Patent Application Publication
(10) Pub. No.: US 2004/0066739 A1
(43) Pub. Date: Apr. 8, 2004

(54) Simplified implementation of optimal decoding for COFDM transmitter diversity system

(75) Inventors: Xuemei Ouyang, Ossining, NY (US); Monisha Ghosh, Chappaqua, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/265,577

(22) Filed: Oct. 7, 2002

(51) Int. Cl. H04J 11/00

(52) U.S. Cl. 370/208

(57) ABSTRACT

A system and method are provided for optimal decoding in a Coded Orthogonal Frequency Division Multiplexing diversity system. The system and method improve the performance of 802.11a receivers by combining optimal maximum likelihood decoding with symbol level decoding such that the performance advantages of optimal maximum likelihood decoding are provided with the same computational complexity as Alamouti symbol level decoding method.

### BACKGROUND OF THE INVENTION

1. Field of the Invention

The present invention relates generally to wireless communications systems. More particularly, the present invention relates to a system and method of optimal decoding for a Coded Orthogonal Frequency Division Multiplexing diversity system. Most particularly, the present invention relates to a system and method for improving the performance of 802.11a receivers that combines optimal maximum likelihood decoding with symbol level decoding such that the performance advantages of optimal maximum likelihood decoding are provided with the same computational complexity as the original Alamouti symbol level decoding method described in [1], which is hereby incorporated by reference as if fully set forth herein.

2. Description of the Related Art

IEEE 802.11a is an important wireless local area network (WLAN) standard powered by Coded Orthogonal Frequency Division Multiplexing (COFDM). An IEEE 802.11a system can achieve transmission data rates from 6 Mbps to 54 Mbps. The highest mandatory transmission rate is 24 Mbps. In order to satisfy high volume multimedia communication, higher transmission rates are needed. Yet, because of the hostile wireless channel the system encounters, to achieve this goal, higher transmission power and/or a strong line-of-sight path becomes a necessity. Since increasing the transmission power will lead to strong interference to other users, the IEEE 802.11a standard constrains the transmission power to 40 mW for transmission in the range of 5.15-5.25 GHz, 200 mW for 5.25-5.35 GHz and 800 mW for 5.725-5.825 GHz. A strong line-of-sight path on a wireless channel can only be guaranteed when the transmitter and receiver are very close to each other, which limits the operating range of the system. Proposed solutions to this problem include soft decoding for architectures using single antenna or dual antennae to improve the performance of 802.11a receivers.

The PHY specification of IEEE 802.11a is given in [2], which is hereby incorporated by reference as if fully set forth herein. FIG. 1 is a detailed illustration of a transceiver of the OFDM PHY of an IEEE 802.11a system as described in [1]. A receiver diagram for soft decoding is illustrated in FIG. 2. The symbol-to-bit mapping before the de-interleaving in the soft decoding process is done by calculating the metrics 20 according to the largest probability for each bit using the received symbol. At the receiver, the faded, noisy version of the transmitted channel symbol is passed through metrics computation units 20 according to equation (1):

$${m}_{i}^{c} ( n ) = {min}_{x ∈ {S}^{C}} {‖ y - hx ‖}^{2} , c = 0 , 1 \qquad ( 1 )$$

where m is the metrics for bit bᵢ in one symbol to be c, where c is either 0 or 1, y is the received symbol, h is the fading and noisy channel estimate, x is the symbol constellation, and S^{c} represents the subset of the constellation point such that bit bᵢ=c. The physical meaning of this equation is that the performance of the calculation of the equation yields the shortest distance between the received symbol and projection of the constellation points in the channel for a certain bit. The underlying idea is illustrated in FIG. 3 in which 30 is a received symbol and the distances are indicated by connecting lines.

The metrics calculated for b₀ and b₁ are obtained using equations (2):

m₀⁰=min(d₀₀,d₀₁),m₀¹=min(d₁₀,d₁₁) (2)

m₁⁰=min(d₀₀,d₁₀),m₁¹=min(d₀₁,d₁₁)

where dᵢⱼ represents the Euclidean distance between the received symbol 30 and the faded constellation point (i,j); mᵢ^{c} represents the soft metrics of bᵢ being c. The pair (m₀⁰,m₀¹) is sent to the Viterbi decoder 21 for Maximum Likelihood (ML) decoding. The same method is applied to obtain b₁ using the pair (m₁⁰,m₁¹). This method can obviously be extended to other modulation schemes, such as BPSK or QAM.

Transmission Diversity is a technique used in multiple-antenna based communications systems to reduce the effects of multi-path fading. Transmitter diversity can be obtained by using two transmission antennae to improve the robustness of the wireless communication system over a multipath channel. These two antennae imply 2 channels that suffer from fading in a statistically independent manner. Therefore, when one channel is fading due to the destructive effects of multi-path interference, another of the channels is unlikely to be suffering from fading simultaneously. A basic transmitter diversity system with two transmitter antennas 50 and 51 and one receiver antenna 42 is illustrated in FIG. 4. By virtue of the redundancy provided by these independent channels, a receiver 42 can often reduce the detrimental effects of fading.

Proposed two transmitter-diversity schemes include Alamouti transmission diversity, which is described in [1]. The Alamouti method provides a larger performance gain than the IEEE 802.11a backward compatible diversity method and is the method used as a performance baseline for the present invention.

The elegant transmission diversity system that has been developed by Alamouti for uncoded (no FEC coding) communication systems [1], and has been proposed as IEEE 802.16 draft standard. In Alamouti's method, two data steams, which are transmitted through two transmitter antennae 50 51, are space-time coded as shown in

TABLE 1

| | Antenna 0 | Antenna 1 |
|---|---|---|
| Time t | S₀ | S₁ |
| Time T + t | −S₁* | S₀* |

where T is the symbol time duration. FIG. 5 illustrates a transmitter diagram for the use of the Alamouti encoding method with an IEEE 802.11a COFDM system. The channel at time t may be modeled by a complex multiplicative distortion h₀(t) 46 for the first antenna 50 and h₁(t) 47 for the second antenna 51. If it is assumed that fading is constant across two consecutive symbols for the OFDM system, the channel impulse response for each subcarrier of the OFDM symbol can be written as

h₀(t)=h₀(t+T)=a₀e^{jθ}^{₀}

h₁(t)=h₁(t+T)=a₁e^{jθ}^{₁} (3)

The received signal can then be expressed as

r₀=r(t)=h₀s₀+h₁s₁+n₀

r₁=r(t+T)=−h₀s₁+h₁s₀+n₁ (4)

Alamouti's original method implements the signal combination as \tilde{s}₀ 44 \tilde{s}₁ 45

\tilde{s}₀=h₀*r₀+h₁r₁*

\tilde{s}₁=h₁*r₀+h₀r₁* (5)

Substituting (4) into (5), results in

\tilde{s}₀=(α₀²+α₁²)s₀+h₀*n₀+h₁n₁*

\tilde{s}₁=(α₀²+α₁²)s₁−h₀n₁*+h₁*n₀ (6)

Then, maximum likelihood detection is calculated as

min∥\tilde{s}₀−(α₀²+α₁²)s₁∥²,s₁εconstellation_points

min∥\tilde{s}₁−(α₀²+α₁²)sₖ∥²,sₖεconstellation_points (7)

In order to obtain the bit metrics for each bit in estimated transmitted symbol \tilde{s}₀ and \tilde{s}₁, the same bit metrics calculation as desribed above can be used. Once obtained, the calculated bit metrics are input to a Viterbi decoder 21 for maximum likelihood decoding.

In optimal maximum likelihood detection, for each received signal pair, r₀ and r₁, to determine whether a transmitted bit in these symbols is ‘1’ or ‘0’, requires computing the largest joint probability as

max(p(r|b)) (8)

where

$$r = ( \begin{matrix}{r}_{0} \\ {r}_{1}\end{matrix} )$$

and b is the bit being determined. This is equivalent to

$$max ( \frac{1}{\sqrt{2 π} σ} {ⅇ}^{- \frac{{‖ {r}_{0} - {h}_{0} {s}_{0} - {h}_{1} {s}_{1} ‖}^{2}}{2 {σ}^{2}}} * \frac{1}{\sqrt{2 π} σ} {ⅇ}^{- \frac{{‖ {r}_{1} + {h}_{0} {s}_{1}^{*} - {h}_{1} {s}_{0}^{*} ‖}^{2}}{2 {σ}^{2}}} \vert {b}_{i} ) = max ( \frac{1}{2 {πσ}^{2}} {ⅇ}^{- \frac{{‖ {r}_{0} - {h}_{0} {s}_{0} - {h}_{1} {s}_{1} ‖}^{2}}{2 {σ}^{2}} - \frac{{‖ {r}_{1} + {h}_{0} {s}_{1}^{*} - {h}_{1} {s}_{0}^{*} ‖}^{2}}{2 {σ}^{2}}} \vert {b}_{i} ) \qquad ( 9 )$$

It is also equivalent to finding bi that satisfies

min((∥r₀−h₀s₀−h₁s₁∥²+∥r₁+h₀s₁*h₁s₀*∥²)|bᵢ) (10)

In order to determine the bit metrics for a bit in symbol r₀, equation (11) is evaulated. That is, for bit i in symbol r₀ to be ‘0’ equation (11) must be evaluated as follows

$${m}_{0 i}^{0} = {min}_{{s}_{m} ∈ {S}^{0} , {s}_{n} ∈ S} ( ( {‖ {r}_{0} - {h}_{0} {s}_{m} - {h}_{1} {s}_{n} ‖}^{2} + {‖ {r}_{1} + {h}_{0} {s}_{n}^{*} - {h}_{1} {s}_{m}^{*} ‖}^{2} ) \vert {b}_{0 i} = 0 ) \qquad ( 11 )$$

where m₀⁰, represents the bit metrics for bit i in received symbol r₀ to be ‘0’, S represents the whole constellation point set, while S⁰ represents the subset of the constellation point set such that bit bᵢ=0. For bit i in symbol r₀ to be ‘1’, equation (12) must be evaluated as follows

$${m}_{0 i}^{1} = {min}_{{s}_{m} ∈ {S}^{1} , {s}_{n} ∈ S} ( ( {‖ {r}_{0} - {h}_{0} {s}_{m} - {h}_{1} {s}_{n} ‖}^{2} + {‖ {r}_{1} + {h}_{0} {s}_{n}^{*} - {h}_{1} {s}_{m}^{*} ‖}^{2} ) \vert {b}_{0 i} = 1 ) \qquad ( 12 )$$

where S¹ represents the subset of the constellation point set such that bit bᵢ=1. Using the same method, bit metrics can be obtained for transmitted symbol r₁. For bit i in symbol r₁ to be ‘0’

$${m}_{1 i}^{0} = {min}_{{s}_{m} ∈ S , {s}_{n} ∈ {S}^{0}} ( ( {‖ {r}_{0} - {h}_{0} {s}_{m} - {h}_{1} {s}_{n} ‖}^{2} + {‖ {r}_{1} + {h}_{0} {s}_{n}^{*} - {h}_{1} {s}_{m}^{*} ‖}^{2} ) \vert {b}_{1 i} = 0 ) \qquad ( 13 )$$

For bit i in symbol r₁ to be ‘1’

$${m}_{1 i}^{1} = {min}_{{s}_{m} ∈ S , {s}_{n} ∈ {S}^{1}} ( ( {‖ {r}_{0} - {h}_{0} {s}_{m} - {h}_{1} {s}_{n} ‖}^{2} + {‖ {r}_{1} + {h}_{0} {s}_{n}^{*} - {h}_{1} {s}_{m}^{*} ‖}^{2} ) \vert {b}_{1 i} = 1 ) \qquad ( 14 )$$

Consider, for example, a QPSK. Bit metrics of b₀ in r₀ can be expressed as (m₀₀⁰,m₀₀¹), where m₀₀^{O} represents the bit metrics of b₀ in received symbol r₀ to be ‘0’ and m₀₀¹ represents the bit metrics of b₀ in received symbol r₀ to be ‘1’. The possibility of combining sₘ and sₙ is illustrated in FIG. 6. Then the bit metrics pairs (m₀₀⁰,m₀₀¹) (m₀₁⁰,m₀₁¹) (m₁₀⁰,m₁₀¹) and (m₁₁⁰,m₁₁¹) are input to the Viterbi decoder 21 for further decoding. The same metrics calculation method can be used in for BPSK and QAM signal.

A typical simulation result is illustrated in FIG. 7, and shows that prior art bit level combining yields better performance than prior art symbol level combining.

### SUMMARY OF THE INVENTION

Trading off the cost of various configurations for the WLAN system to obtain performance improvement, a two antennae scheme can be relatively inexpensively and can be more easily implemented into each access point (AP), and all the mobile stations can use a single antenna each. In such an architecture, each AP can then take advantage of transmitting diversity and receiving diversity with almost the same performance improvement for downlink and uplink and at no cost for the associated mobile stations. Dual antennae systems can be divided into two types, namely two transmitting antennae-single receiving antenna system and single transmission antenna-two-receiver antennae system. The system and method of the present invention provides a decoding method that results in both dual antennae systems performing better than a single antenna system

Although the bit level decoding of the prior art can provide better performance than the symbol level combining of the prior art, the computational complexity is much higher than for symbol level combining. Especially for QAM signals, the number of combinations of possibilities of constellation points of sₘ and sₙ can be very large. Taking 64 QAM signal as an example, to get the metrics for one bit to be ‘0’ in transmitted symbol s₀, it is necessary to find the smallest value for

$$( {‖ {r}_{0} - {h}_{0} {s}_{m} - {h}_{1} {s}_{n} ‖}^{2} + {‖ {r}_{1} + {h}_{0} {s}_{n}^{*} - {h}_{1} {s}_{m}^{*} ‖}^{2} ) in ( \begin{matrix}1 \\ 32\end{matrix} ) * ( \begin{matrix}1 \\ 64\end{matrix} ) = 32 * 64 = 2048$$

combinations of sₘ and sₙ. The same amount computation is needed to obtain the metrics for the same bit to be ‘1’.

The system and method of the present invention provides a less computationally intensive approach by combining optimal maximum likelihood decoding with symbol level decoding, thereby providing the combined merits of bit level optimum maximum likelihood decoding and Alamouti symbol level decoding. That is, the decoding system and method of the present invention can achieve approximately the same performance gain as bit level optimum maximum likelihood decoding but with approximately the same computational complexity as the original Alamouti decoding method.

### BRIEF DESCRIPTION OF THE DRAWINGS

FIG. 1a is an example of a transmitter block diagram for the OFDM PHY.

FIG. 1b is an example of a receiver block diagram for the OFDM PHY.

FIG. 2 illustrates soft decision detection in an IEEE802.11a receiver.

FIG. 3 illustrates metrics calculation employing Euclidean distance.

FIG. 4 illustrates a basic transmitter diversity system with two transmitter antennae and one receiver antenna.

FIG. 5 illustrates Alamouti space-time coding for IEEE 802.11a OFDM system transmitter diversity.

FIG. 6 illustrates bit metrics calculation for QPSK signal.

FIG. 7 provides a performance comparison for a simulation of symbol level decoding vs. bit level decoding of the prior art for the mode of 12 Mbps.

FIG. 8 illustrates a transmitter diversity system with two transmitter antennae and one receiver antenna according to the present invention.

FIG. 9 provides a performance comparison for a simulation of modified symbol level decoding and bit level decoding according to the present invention for the mode of 12 Mbps.

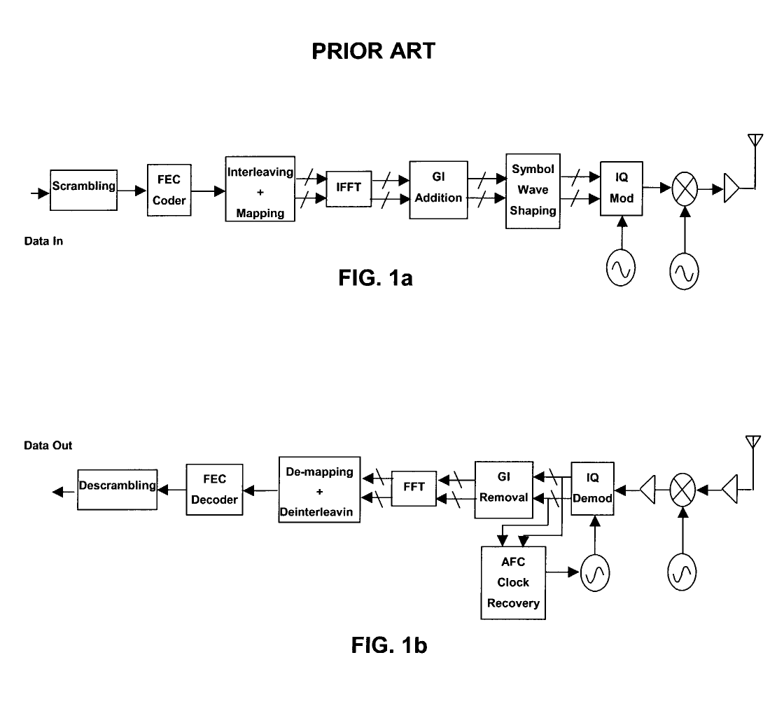

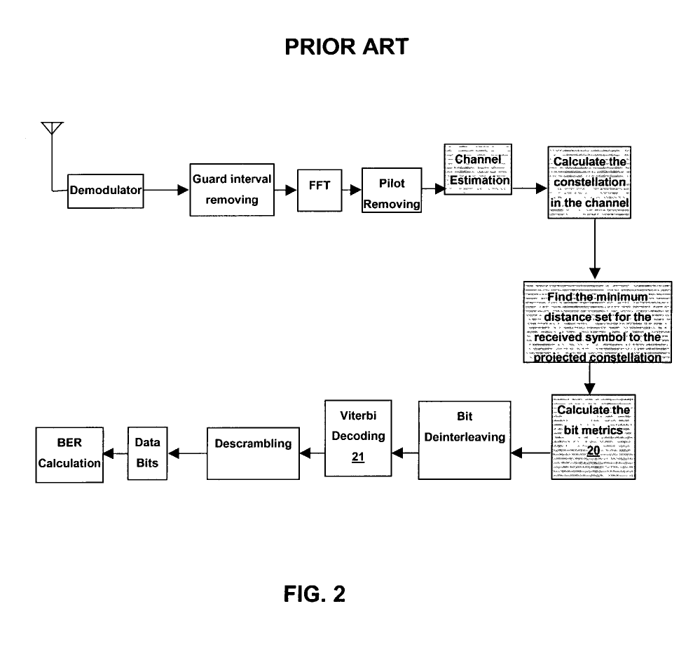

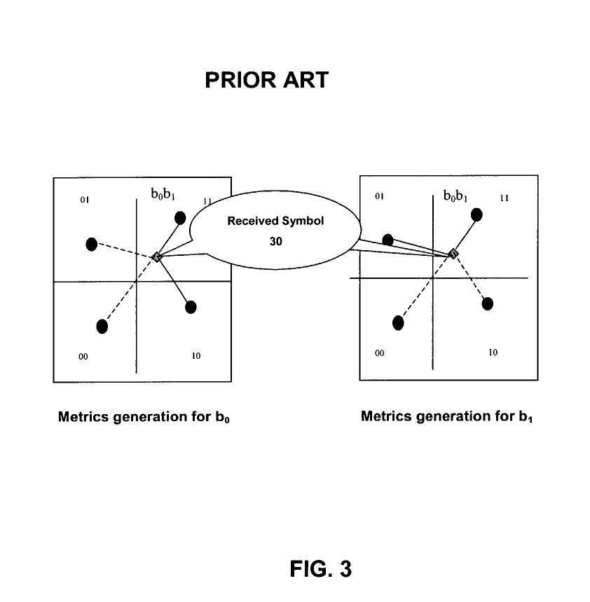

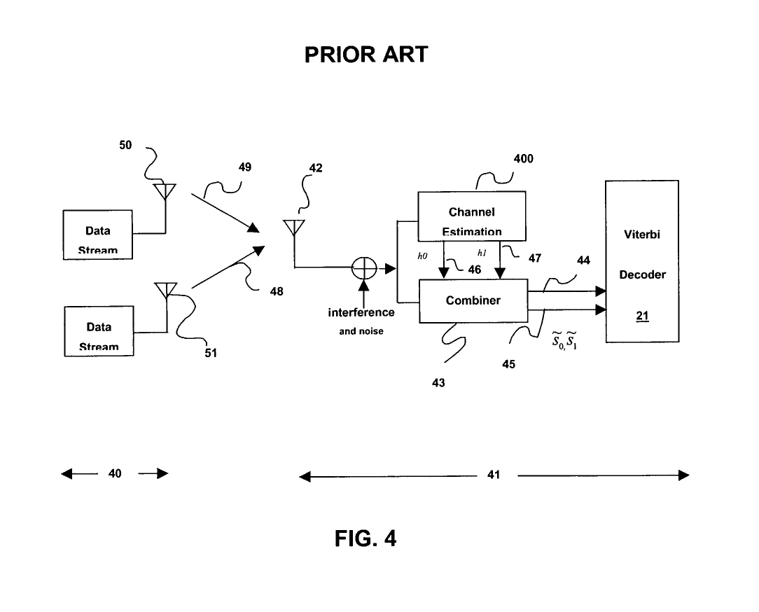

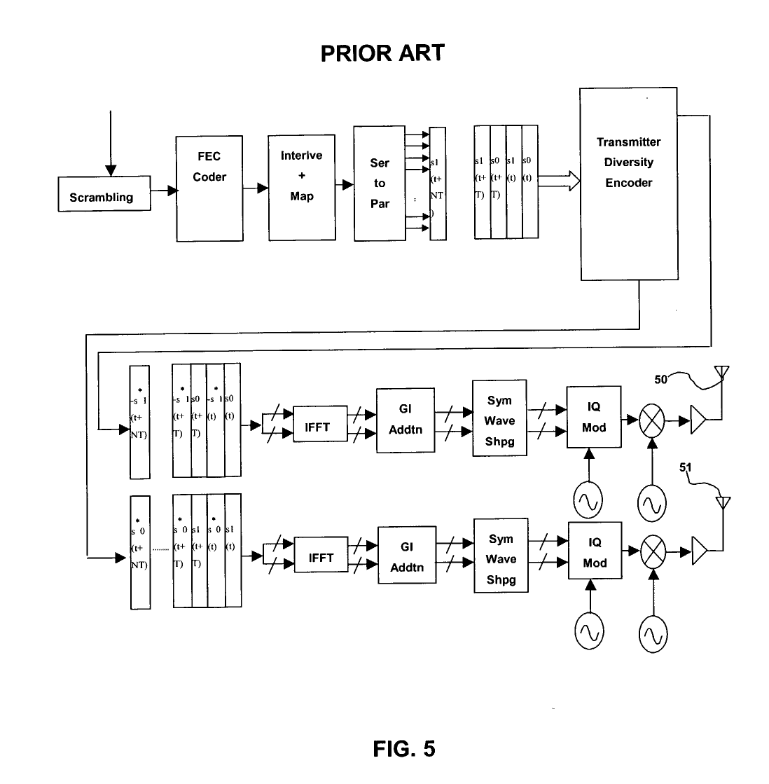

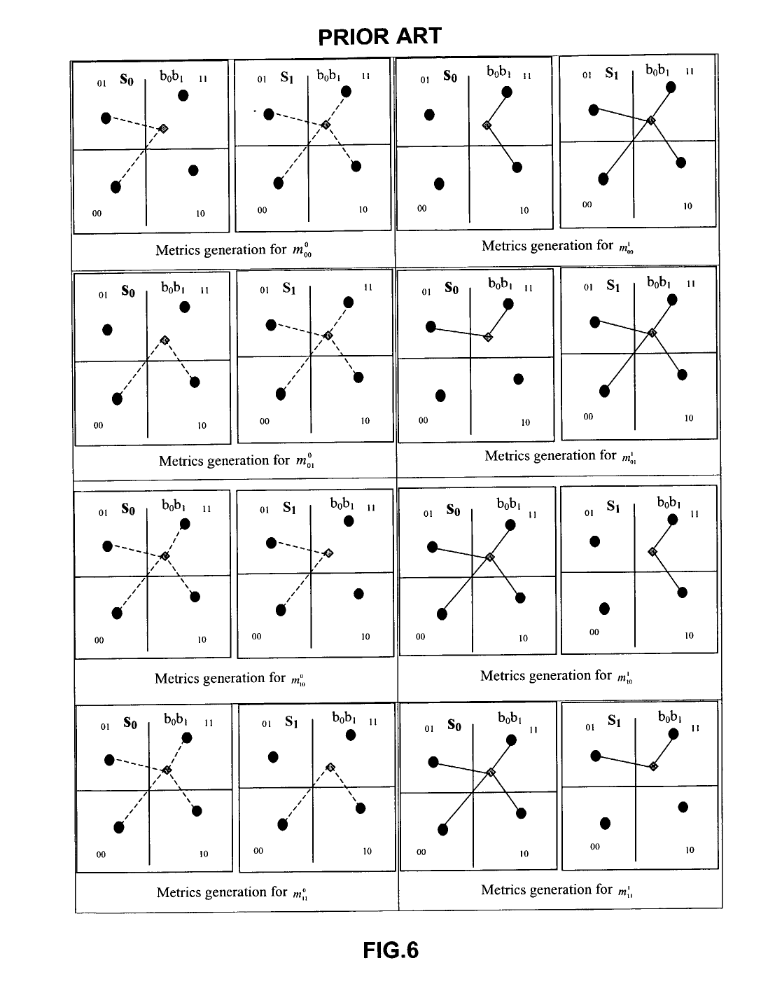

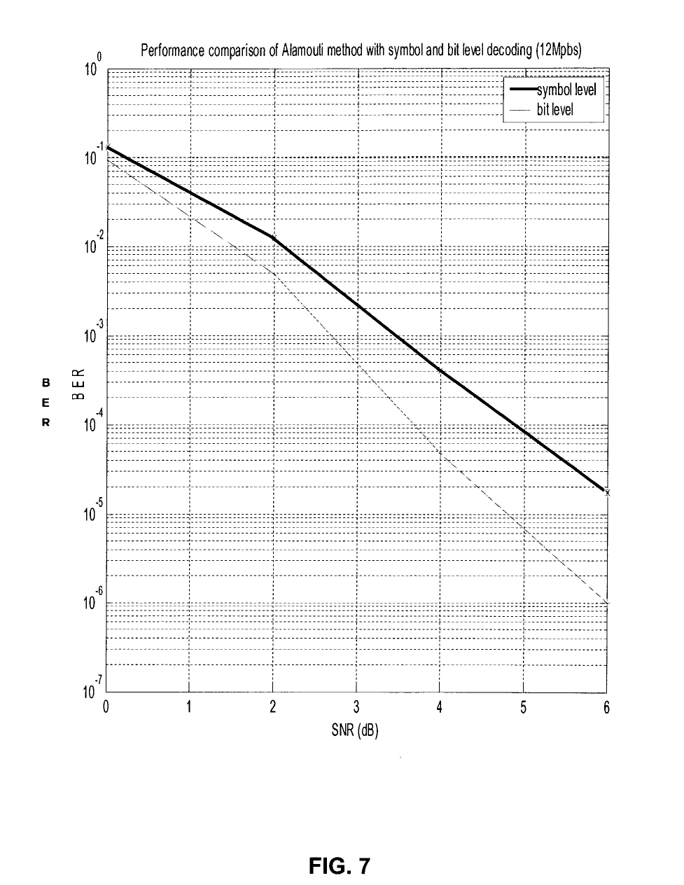

### DETAILED DESCRIPTION OF THE INVENTION

The present invention considers the relationship of the Alamouti decoding method and optimum maximum likelihood decoding from a different point of view than previously. Optimal maximum likelihood decoding requires determining

$$\begin{matrix}{min}_{{s}_{k} ∈ {S}^{p}} {‖ r - H s ‖}^{2} = {min}_{{s}_{k} ∈ {S}^{p}} ( {‖ {r}_{0} - {h}_{0} {s}_{0} - {h}_{1} {s}_{1} ‖}^{2} + \\ {‖ {r}_{1} + {h}_{1} {s}_{0}^{*} - {h}_{0} {s}_{1}^{*} ‖}^{2} ) \\ = {min}_{{s}_{k} ∈ {S}^{p}} {‖ ( \begin{matrix}{r}_{0} \\ {r}_{1}^{*}\end{matrix} ) - ( \begin{matrix}{h}_{0} & {h}_{1} \\ {h}_{1}^{*} & - {h}_{0}^{*}\end{matrix} ) ( \begin{matrix}{s}_{0} \\ {s}_{1}^{*}\end{matrix} ) ‖}^{2} \\ = {min}_{{s}_{k} ∈ {S}^{p}} {‖ ( \begin{matrix}{r}_{0} - {h}_{0} {s}_{0} - {h}_{1} {s}_{1} \\ {r}_{1}^{*} - {h}_{1}^{*} {s}_{0} + {h}_{0}^{*} {s}_{1}\end{matrix} ) ‖}^{2} \\ = {min}_{{s}_{k} ∈ {S}^{p}} {( \begin{matrix}{r}_{0} - {h}_{0} {s}_{0} - {h}_{1} {s}_{1} \\ {r}_{1}^{*} - {h}_{1}^{*} {s}_{0} + {h}_{0}^{*} {s}_{1}\end{matrix} )}^{H} ( \begin{matrix}{r}_{0} - {h}_{0} {s}_{0} - {h}_{1} {s}_{1} \\ {r}_{1}^{*} - {h}_{1}^{*} {s}_{0} + {h}_{0}^{*} {s}_{1}\end{matrix} ) , \\ p ∈ \{ 0 , 1 \}\end{matrix} \qquad ( 15 )$$

where r₀, r₁, s₀, s₁, h₀ and h₁ have been defined in equation (2) and (3) and symbols are space-time encoded as shown in Table 1 by a coder (not shown) of an output stage 40 as two data streams; * stands for complex conjugate, ∥.∥ for amplitude of complex matrix or complex value and ( )^{H} for conjugate transport; and

$$H = ( \begin{matrix}{h}_{0} & {h}_{1} \\ {h}_{1} & - {h}_{0}\end{matrix} )$$

is the channel coefficients matrix.

Define

$$K = ( \begin{matrix}{h}_{0} & {h}_{1} \\ {h}_{1}^{*} & - {h}_{0}^{*}\end{matrix} ) and a = ( \begin{matrix}{r}_{0} \\ {r}_{1}^{*}\end{matrix} ) \qquad ( 16 )$$

such that

min∥r−Hs∥²=min∥a−Ks∥² (17)

Multiplying (a−Ks) with K^{H} yields

$$min {‖ {K}^{H} a - {K}^{H} Ks ‖}^{2} = min {‖ ( \begin{matrix}{h}_{0}^{*} & {h}_{1} \\ {h}_{1}^{*} & - {h}_{0}\end{matrix} ) ( \begin{matrix}{r}_{0} \\ {r}_{1}^{*}\end{matrix} ) - ( \begin{matrix}{h}_{0}^{*} & {h}_{1} \\ {h}_{1}^{*} & - {h}_{0}\end{matrix} ) ( \begin{matrix}{h}_{0} & {h}_{1} \\ {h}_{1}^{*} & - {h}_{0}^{*}\end{matrix} ) ( \begin{matrix}{s}_{0} \\ {s}_{1}\end{matrix} ) ‖}^{2} = min {‖ ( \begin{matrix}{\tilde{s}}_{0} \\ {\tilde{s}}_{1}\end{matrix} ) - ( {\vert {h}_{0} \vert}^{2} + {\vert {h}_{1} \vert}^{2} ) ( \begin{matrix}{s}_{0} \\ {s}_{1}\end{matrix} ) ‖}^{2} = min ( ‖ {\tilde{s}}_{0} - ( {\vert {h}_{0} \vert}^{2} + {\vert {h}_{1} \vert}^{2} ) {s}_{0} {‖}^{2} + ‖ {\tilde{s}}_{1} - ( {\vert {h}_{0} \vert}^{2} + {\vert {h}_{1} \vert}^{2} ) {s}_{1} {‖}^{2} ) \qquad ( 18 )$$

where \tilde{s}₀ 44 and \tilde{s}₁ 45 are defined in equation (5). This is equivalent to finding the s₀ 44 that minimizes ∥\tilde{s}₀−(∥h₀|²+|h₁|²)s₀∥² and the s₀ 45 that minimizes ∥\tilde{s}₁−(|h₀|²+|h₁|²)s₁∥², respectively, which is precisely the operation of Alamouti decoding.

Expressing (18) in another way yields the equation

min∥K^{H}a−K^{H}Ks∥²=min(a−Ks)^{H}KK^{H}(a−Ks) (19)

Since

$${KK}^{H} = ( \begin{matrix}{h}_{0} & {h}_{1} \\ {h}_{1}^{*} & - {h}_{0}^{*}\end{matrix} ) ( \begin{matrix}{h}_{0}^{*} & {h}_{1} \\ {h}_{1}^{*} & - {h}_{0}\end{matrix} ) = ( {‖ {h}_{0} ‖}^{2} + {‖ {h}_{1} ‖}^{2} ) I \qquad ( 20 )$$

then

min∥K^{H}a−K^{H}Ks∥²=(∥h₀∥²+∥h₁∥²)min∥a−Ks∥²=(∥h₀∥²+∥h₁∥²)min∥r−Hs∥² (21)

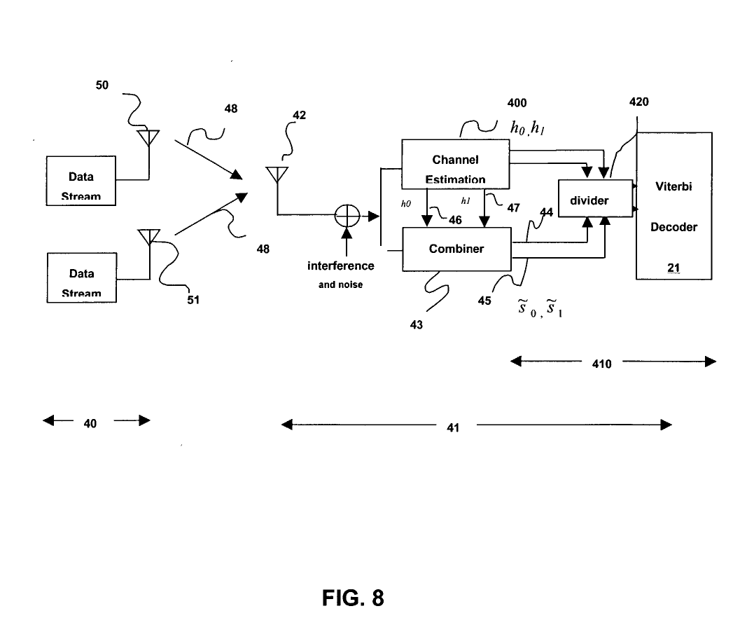

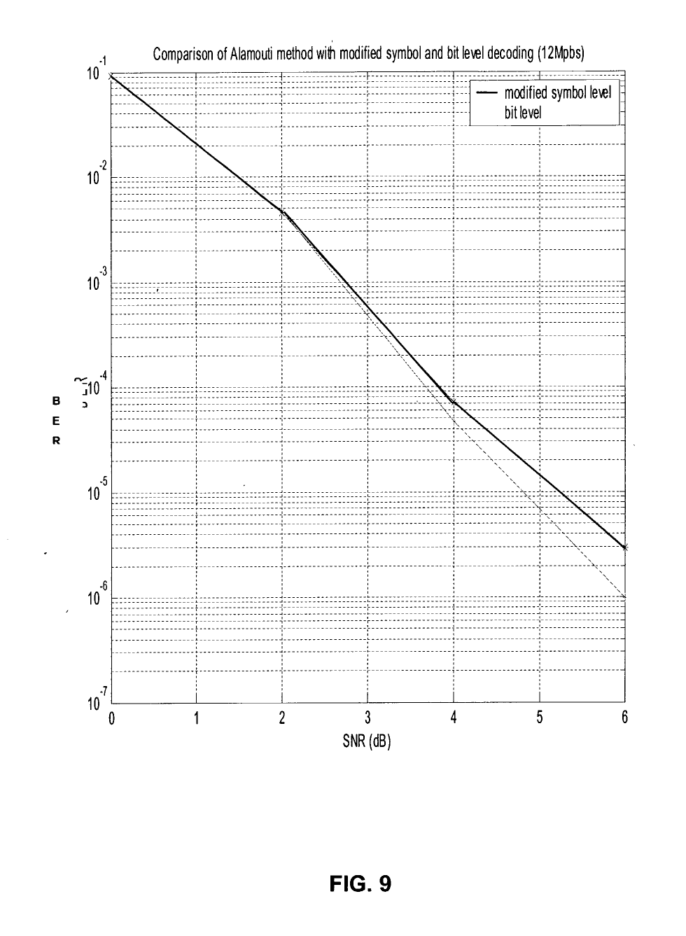

Thus, preferably using a divider 420, the present invention divides the bit metrics calculated from the Alamouti method by (∥h₀∥²+∥h₁∥²) so that the same optimum maximum likelihood bit metrics are obtained as that of bit level decoding. FIG. 8 illustrates a detector 410 comprising a divider 420 for accomplishing the division and forming a divided signal and a Viterbi decoder 21 for decoding the divided signal. FIG. 9 illustrates simulation results that confirm this analysis and demonstrate a typical performance advantage of the symbol level combining and decoding of the present invention over bit level decoding.

For the case of no FEC coding system, hard decision decoding is the method of choice, which means that a received symbol is decoded as the symbol that has the smallest Euclidean distance between the constellation point and the received symbol. The bits in each symbol do not affect the bits in any other received symbols. Thus, equations min∥K^{H}a−K^{H}Ks∥² and min∥r−Hs∥² yield an identical decoding result. Yet for an FEC (convolutional) coded system, bit metrics calculated for bits in more than one received symbol could have an effect on a single decoded bit. Thus the decoding results for (∥h₀∥²+∥h₁∥²)min∥r−Hs∥² and min∥r−Hs∥² will be different.

For a single antenna system, a maximum likelihood decoder that combines channel equalization with maximum likelihood detection can provide a 4-5 dB performance gain over a decoder that separates the operation of channel equalization and detection.

For IEEE 802.11a/g, simulation results show that Alamouti transmitter diversity with optimal bit level maximum likelihood decoding can provide 2-5 dB performance gain over a single antenna system, depending on different transmission rate.

The symbol level optimal decoding method of the present invention provides the same performance as the optimal bit level decoding but with much less complexity for the implementation.

While the examples provided illustrate and describe a preferred embodiment of the present invention, it will be understood by those skilled in the art that various changes and modifications may be made, and equivalents may be substituted for elements thereof without departing from the true scope of the present invention. In addition, many modifications may be made to adapt the teaching of the present invention to a particular situation without departing from the central scope. Therefore, it is intended that the present invention not be limited to the particular embodiment disclosed as the best mode contemplated for carrying out the present invention, but that the present invention include all embodiments falling within the scope of the appended claims.

### REFERENCES

The following references are hereby incorporated by reference as if fully set forth herein.

[1] Siavash M. Alamouti, A Simple Transmit Diversity Technique for Wireless Communication, IEEE Journal on Select Areas in communications, Vol. 16, No. 8, October 1998.

[2] Part 11: Wireless LAN Medium Access Control (MAC) and Physical Layer (PHY) specifications: High-speed Physical Layer in the 5 GHz Band, IEEE Std 802.11a-1999.

[2] Xuemei Ouyang, Improvements to IEEE 802.11a WLAN Receivers, Internal Technical Notes, Philips Research USA—TN-2001-059, 2001.

1. A transmit diversity apparatus comprising:
an output stage for transmitting over a first and second antenna a first and second encoded sequence of channel symbols for a first and second incoming signal s₀ and s₁;
a receiver for receiving a first and second received signal r₀ and r₁ corresponding to said first and second transmitted and encoded sequence, respectively;
a combiner at said receiver for building a first and a second combined signal from said first and second received signal r₀ and r₁; and
a detector at said receiver, said detector responsive to said combined signals that develops decisions based on combined bit level optimal maximum likelihood decoding and symbol level decoding.

2. The apparatus of claim 1, wherein the encoding is in blocks of two symbols.

3. The apparatus of claim 2, wherein said first encoded sequence of symbols is s₀ and −s₁* and said second encoded sequence of symbols is s₁ and s₀*, where sᵢ* is the complex conjugate of s₁ and the sequence of symbols are space-time coded.

4. The apparatus of claim 3, wherein:
said first and second received signal received at time t and t+T by said receiver respectively correspond to
r₀=r(t)=h₀s₀+h₁s₁+n(t)
r₁=r(t+T)=−h₀s₁*+h₁s₀*+n(t+T); and
said combiner builds said first and second combined signal by forming respective signal
\tilde{s}₀=h₀*r(t)+h₁r*(t+T)
\tilde{s}₁=h₁*r(t)−h₀r*(t+T)′
wherein, a channel at time t is modeled by a complex multiplicative distortion h₀(t) for said first antenna and a channel at time t is modeled by a complex multiplicative distortion h₁(t) for said second tantenna, n(t) and n(t+T) are noise signals at time t and t+T, and * represents the complex conjugate operation.

5. The appartus of claim 4, wherein the detector selects a symbol s₀ and s₁ based on optimum maximum likelihood decoding combined with symbol level decoding corresponding to
min(∥\tilde{s}₀−(∥h₀∥²+∥h₁∥²)s₀∥²+∥\tilde{s}₁−(∥h₀∥²+∥h₁∥²)s₁∥²)
wherein s₀ is selected to minimize
∥\tilde{s}₀−(∥h₀∥²+∥h₁∥²)s₀∥²
and s₁ is selected to minimize
∥\tilde{s}₁−(∥h₀∥²+∥h₁∥²)s₁∥².

6. The apparatus of claim 1, wherein said apparatus provides optimal decoding for a Coded Orthogonal Frequency Division Multiplexing diversity system.

7. A receiver comprising:
a combiner for building a first and a second combined symbol estimate from a first and second signal r₀ and r₁ received by a receiver antenna for a first and a second concurrent space diverse path over which said first and second signal r₀ and r₁ arrive at said receiver antenna, said first and second signal having symbols embedded therein; and
a detector responsive to said first and second combined symbol estimate that develops decisions based on a combination of bit level optimal maximum likelihood decoding and symbol level decoding regarding symbols embedded in said first and second signal received by said receiver antenna.

8. The receiver of claim 7, wherein:
said first and second received signal are received by said antenna at time t and t+T, respectively, and correspond to
r₀=r(t)=h₀s₀+h₁s₁+n(t)
r₁=r(t+T)=−h₀s₁*+h₁s₀*+n(t+T); and
said combiner respectively builds said first and second combined signal as
\tilde{s}₀=h₀*r(t)+h₁r*(t+T)
\tilde{s}₁=h₁*r(t)−h₀r*(t+T)
wherein, a channel at time t is modeled by a complex multiplicative distortion h₀(t) for said first path and a channel at time t is modeled by a complex multiplicative distortion h₁(t) for said second path, n(t) and n(t+T) are noise signals at time t and t+T, and * represents the complex conjugate operation and a first and second symbol s₀ and s₁ are space-time coded into a first and second data stream received as said first and second received signals r₀ and r₁, said space-time coding being accomplished according to
$$\begin{matrix} & First data stream & Second data stream \\ Time t & {s}_{0} & {s}_{1} \\ Time t + T & - {s}_{1}^{*} & {s}_{0}^{*}\end{matrix}$$

9. The receiver of claim 8, wherein the detector selects a symbol s₀ and s₁ based on optimum maximum likelihood decoding combined with symbol level decoding corresponding to
min(∥\tilde{s}₀−(∥h₀∥²+∥h₁∥²)s₀∥²+∥\tilde{s}₁−(∥h₀∥²+∥h₁∥²)s₁∥²)
wherein s₀ is selected to minimize
∥\tilde{s}₀−(∥h₀∥²+∥h₁∥²)s₀∥²
and s₁ is selected to minimize
∥\tilde{s}₁−(∥h₀∥²+∥h₁∥²)s₁∥².

10. The receiver of claim 7, wherein said receiver provides optimal decoding for a Coded Orthogonal Frequency Division Multiplexing diversity system.

11. An arrangement comprising:
a coder responsive to incoming symbols, forming a set of channel symbols;
an output stage that applies said channel symbols simultaneously to a first and second transmitter antenna to form a first and second channel over a transmission medium;
a receiver having a single receiver antenna that is adapted to receive and decode a first and second received signal transmitted by said output stage, said decoding being a combination of optimal maximum likelihood decoding with symbol level decoding, wherein the symbol level optimal decoding provides the same performance as optimal bit level decoding but with much less computational complexity.

12. The arrangement of claim 11, wherein in response to a sequence {s₀, s₁, s₂, s₃, s₄, s₅, . . . } of incoming symbols said coder develops a sequence {s₀, −s₁*, s₂, −s₃*, s₄, −s₅*, . . . } that is applied to said first antenna by said output stage simultaneously with a sequence {s₁,s₀*,s₃,s₂*,s₅,s₄*, . . . } that is applied to said second antenna by said output stage, such that s₁* is the complex conjugate of sᵢ such that said symbols are space-time coded into a first and second data stream according to protocol
$$\begin{matrix} & First data stream & Second data stream \\ Time t & {s}_{0} & {s}_{1} \\ Time t + T & - {s}_{1}^{*} & {s}_{0}^{*} \\ ⋯ & ⋯ & ⋯\end{matrix}$$

13. The arrangement of claim 12, wherein:
said first and second received signal are received by said antenna at time t and t+T, respectively, and correspond to
r₀=r(t)=h₀s₀+h₁s₁+n(t)
r₁=r(t+T)=−h₀s₁*+h₁s₀*+n(t+T); and
said receiver further comprises a combiner for respectively building a first and second combined signal as
\tilde{s}₀=h₀*r(t)+h₁r*(t+T)
\tilde{s}₁=h₁*r(t)−h₀r*(t+T)′
wherein, a channel at time t is modeled by a complex multiplicative distortion h₀(t) for said first transmitter antenna and a channel at time t is modeled by a complex multiplicative distortion h₁(t) for said second transmitter antenna, n(t) and n(t+T) are noise signals at time t and t+T.

14. The appartus of claim 13, wherein said optimum maximum likelihood decoding combined with symbol level decoding corresponds to
min(∥\tilde{s}₀−(∥h₀∥²+∥h₁∥²)s₀∥²+∥\tilde{s}₁−(∥h₀∥²+∥h₁∥²)s₁∥²)
wherein s₀ is selected to minimize
∥\tilde{s}₀−(∥h₀∥²+∥h₁∥²)s₀∥²
and s₁ is selected to minimize
∥\tilde{s}₁−(∥h₀∥²+∥h₁∥²)s₁∥².
and the values
min(∥\tilde{s}₀−(∥h₀∥²+∥h₁∥²)s₀∥²)/∥h₀∥²+∥h₁∥² and
min(∥\tilde{s}₁−(∥h₀∥²+∥h₁∥²)s₁∥²)/∥h₀∥²+∥h₁∥²
are calculated by a divider and sent to a Viterbi decoder for decoding.

15. The arrangement of claim 11, wherein said receiver provides optimal decoding for a Coded Orthogonal Frequency Division Multiplexing diversity system.

16. A method for decoding incoming symbols, comprising the steps of:
receiving by a receiver antenna a first and second received signal over a respective first and second concurrent space diverse path, said first and second received signal comprising a respective first and second encoded sequence of symbols;
developing a respective first and second channel estimate for said respective first and second space diverse path;
combining said first and second received signal with said respective first and second channel estimate to form a respective first and second combined symbol estimate; and
decoding by a decoder said first and second combined symbol estimate with a combination of bit level optimal maximum likelihood decoding and symbol level decoding to form a respective first and second detected symbol,
wherein the symbol level optimal decoding provides the same performance as optimal bit level decoding but with much less computational complexity.

17. The method of claim 16, wherein said method further comprises the substeps of:
encoding incoming symbols to form a first and second channel symbol for a first and second space diverse channel;
concurrently transmitting over said first and second space diverse channel of said first and second channel symbol by a first and second transmitter antenna, respectively.
